(19) United States
(12) Patent Application Publication
(10) Pub. No.: US 2012/0248182 A1
(43) Pub. Date: Oct. 4, 2012

(54) METHOD FOR ASSOCIATING A PRINTABLE OPTICAL CODE WITH AN EMAIL MESSAGE

(75) Inventors: Kurt E. Partridge, Palo Alto, CA (US); Diana K. Smetters, Belmont, CA (US)

(73) Assignee: PALO ALTO RESEARCH CENTER INCORPORATED, Palo Alto, CA (US)

(21) Appl. No.: 13/079,651

(22) Filed: Apr. 4, 2011

(51) Int. Cl. G06F 17/00

(52) U.S. Cl. 235/375

(57) ABSTRACT

One embodiment provides a system for printing a document from a portable device. During operation, the system receives a hyperlink associated with an email and a document to be printed. Next, the system obtains a document optical code that identifies the document computer-readable storage device. Subsequently, the system displays the optical code to a printing device, thereby allowing the printing device to obtain and print the document.

### BACKGROUND

1. Field

The present disclosure relates generally to communication with peripheral devices. More specifically, the present disclosure relates to a method and system for printing documents from a portable device to any printer without discovering and loading a driver for a printer.

2. Related Art

The proliferation of portable devices is changing the way people work. For example, people receive emails with document attachments that can include large documents, presentation slides, and schedules. Typically, such attachments are difficult to read on the portable device because of limited screen sizes. At the same time, printing from the portable device is difficult for several reasons. The portable device might not have enough memory or computing power to support printer drivers. A printer driver designed for the operating system on the portable device might not be available. The portable device is often required to discover nearby printers in a new environment, which can be time-consuming and might not always be successful. Furthermore, the portable device might not have secure network access to the printer, thus introducing security concerns in the printing process.

Current solutions to printing from a portable device are complicated. A portable device must follow a complicated series of steps, including discovering the printer, downloading software drivers, creating an account, uploading documents, logging into the printer, and selecting documents. In addition, printing from a portable device requires new costly and/or retrofitted hardware, such as Bluetooth®, WiFi®, RFID, NFC, USB, and 1rDA.

### SUMMARY

One embodiment provides a system for printing a document from a portable device. During operation, the system receives a hyperlink associated with a document. Next, the system follows the hyperlink and obtains a document optical code. Subsequently, the system displays the optical code to a printing device, thereby allowing the printing device to obtain and print the document.

In some embodiments, the hyperlink is included in an email header, in an email body, or in an attachment to an email.

In some embodiments, the hyperlink is included in a Short Message Service (SMS) message.

In some embodiments, the hyperlink points to the document optical code.

In some embodiments, obtaining the document optical code further involves following the hyperlink to download the optical code.

In some embodiments, the hyperlink points to the document to be printed.

In another variant of the embodiment, obtaining the document optical code involves generating the optical code corresponding to the document when the hyperlink is followed.

In some embodiments, the hyperlink includes a hash of the document optical code for verification.

In some embodiments, obtaining the document optical code involves authenticating the portable device.

### BRIEF DESCRIPTION OF THE FIGURES

FIG. 1 illustrates an exemplary system for printing documents from a portable device, in accordance with an embodiment of the present invention.

FIG. 2 presents a flow chart illustrating the process of downloading a document optical code at a portable device, in accordance with an embodiment of the present invention.

FIG. 3 presents a flow chart illustrating the process of generating a document optical code at a portable device, in accordance with an embodiment of the present invention.

FIG. 4 presents a flow chart illustrating the process of facilitating document printing at an email/document server, in accordance with an embodiment of the present invention.

FIG. 5 illustrates the process of controlling access to the document optical code, in accordance with an embodiment of the present invention.

FIG. 6 illustrates an exemplary portable device for printing a document from a portable device, in accordance with an embodiment of the present invention.

FIG. 7 illustrates an exemplary email/document server for facilitating document printing from a portable device, in accordance with an embodiment of the present invention.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention solve the problem of printing a document from a portable device by providing a hyperlink to a mobile device. Upon the hyperlink being followed, the mobile device obtains and displays a document optical code. The user can display the optical code to a scanner associated with a printer, which in turn can scan and recognize the optical code. Based on the information contained in the optical code, the printer (or a computer associated with the printer) can then retrieve the document from a server on a network and print the document.

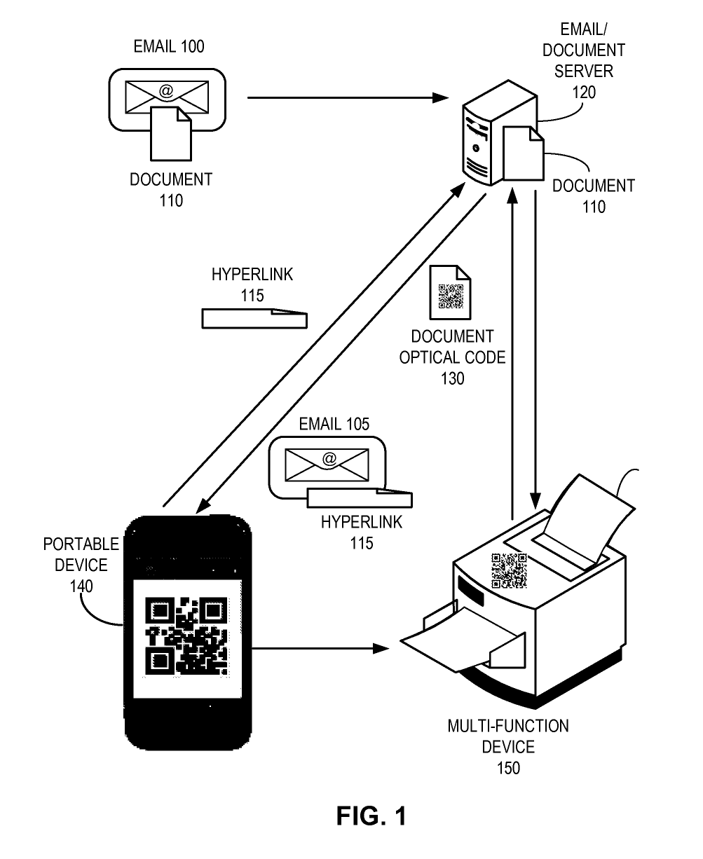

This basic idea of using an optical code to facilitate printing from a portable device without any printer discovery or driver installation can be applied in different computing environments. One such example is illustrated by the system shown in FIG. 1, which facilitates printing documents from a portable device in accordance with an embodiment. In this example, an email 100 addressed to a user is sent with an attached document 110 to an email/document server 120. A user of portable device 140 checks emails from server 120. In some embodiments, the emails can be “pushed” to portable device 140 by server 120. In response to the user's email download request, server 120 creates an optical code 130 for the attached document and embeds a hyperlink 115 that points to the optical code in email 105 before sending it to portable device 140. If the user decides to print document 110, he follows hyperlink 115 to obtain document optical code 130. The user then places the portable device's screen, which is displaying document optical code 130, on the flatbed scanner of a multi-function device (MFD) 150. MFD 150 scans the portable device's screen, decodes optical code 130, and retrieves document 110 from server 120. Subsequently, MFD 150 prints document 110. In this example, it is assumed that the printing service described herein is provided by an email service provider, or a wireless service provider that also offers document-hosting and/or optical-code generation.

In this description, optical code 130 can be any optical representation of information that can be captured and recognized by any optical-sensing device, such as a scanner or digital camera. Typical optical codes include, but are not limited to: one-dimensional barcodes, two-dimensional barcodes (also called matrix codes, such as the “Quick Response” or “QR” codes), and data glyphs.

Email/document server 120 can store document 110 at a publicly accessible location which can be identified by hyperlink 115 such as a universal resource locator (URL). Furthermore, email/document server 120 can also be part of portable device 140, which means that the document is saved on portable device 140 with a hyperlink that can be accessed by MFD 150. In addition, MFD 150 can also be a conventional printer coupled to a computer which is also coupled to a scanner. The computer and scanner jointly perform the scanning and recognition of optical code 130.

The document print system illustrated in the example in FIG. 1 offers several benefits. First, there is no need for portable device 140 to discover MFD 150 electronically or to download any printer driver. As long as the user of portable device 140 can visually locate a printer and display optical code 130 to the associated scanner, the printing can be performed. Portable device 140 also does not need to download an optical code upfront with the email, which saves time and power. Furthermore, this method is not limited to particular document formats or printer types, because it does not require any document transfer or handshaking process between the portable device and the printer. In addition, the system supports all portable devices and can be modified to work on mobile devices with few features. The system works with most network configurations, e.g., over a local area network (LAN), a wide-area network (WAN), a proprietary network, or the Internet.

Note that this disclosure uses the term “document optical code” interchangeably with “optical code.” Furthermore, the terms “printer” and “multi-function device” are used interchangeably in this disclosure. Functions, methods, and operations described in this disclosure to be performed by a printer or an MFD can also be performed by a computer associated with the printer or MFD.

Printing from a Portable Device

In the exemplary document-printing system illustrated in FIG. 1, server 120 may attach optical code to the email and send it to the user in response to the user's email download request. However, sending optical codes as attachments increases the amount of data transferred to portable device 140. This can be particularly troublesome when the data link between the portable device and the server is slow and there are a large number of optical codes to download. Embodiments of the present invention provide a system that generates a hyperlink pointing to the optical code and sends the hyperlink to the portable device. The hyperlink may be included in the header of the email, at the beginning or the end of the message body, or in an attachment of its own (which will take many fewer bits than an optical code). The hyperlink may also be sent to the user separately via other message format such as SMS. When included in the email, it is desirable to distinguish the hyperlink by formatting it differently from the rest of the email.

In one embodiment, the hyperlink points to the document optical code. Following the hyperlink causes the mobile device to download the optical code. In this case, the email/document server can upload the document to a web-accessible location and generate an optical code associated with the document before sending the hyperlink to the user.

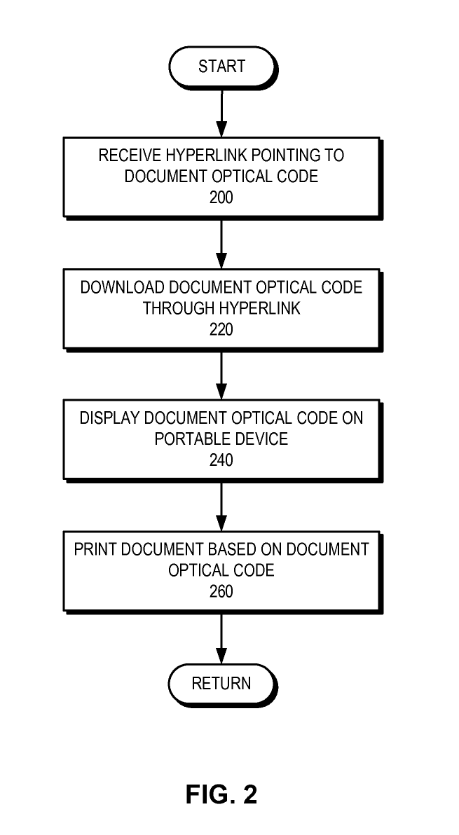

FIG. 2 presents a flow chart illustrating the process of downloading a document optical code at a portable device in accordance with an embodiment. During operation, the portable device receives a hyperlink pointing to a document optical code that identifies the document to be printed (operation 200). The portable device then downloads the document optical code via the hyperlink (operation 220). Subsequently, the portable device displays the document optical code on the portable device (operation 240). The optical code is displayed in such a way that it can be scanned and recognized by a scanner associated with a printer. Next, the portable device allows the printer to retrieve and print the document based on the document optical code (operation 260).

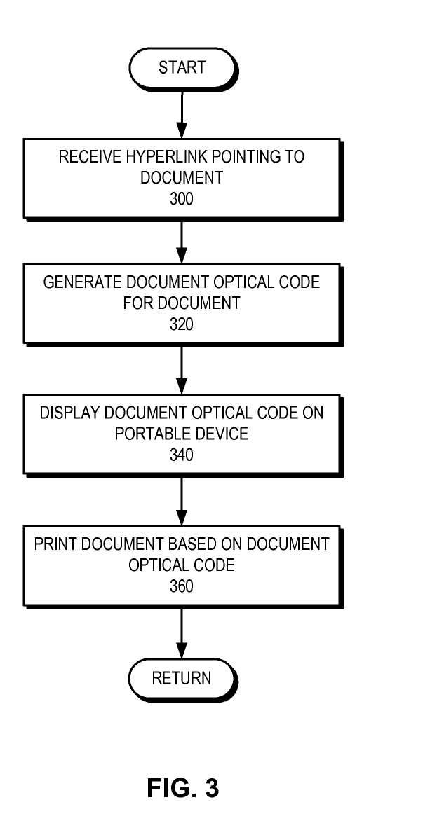

In another embodiment, the hyperlink points directly to the document. The document is uploaded to a web-accessible location in response to the user's clicking of the hyperlink. At the same time, a corresponding optical code is generated by the portable device. This removes the requirement to download the optical code and shortens the time needed before the optical code can be displayed and scanned. FIG. 3 presents a flow chart illustrating the process of generating a document optical code at a portable device a portable device in accordance with an embodiment. During operation, the portable device receives a hyperlink pointing to the document to be printed (operation 300). The portable device then generates a document optical code that identifies the document (operation 320). Subsequently, the portable device displays the document optical code for the MFD to scan (operation 340). Next, the portable device allows the MFD to print the document based on the document optical code (operation 360).

### Email/Document Server Operations

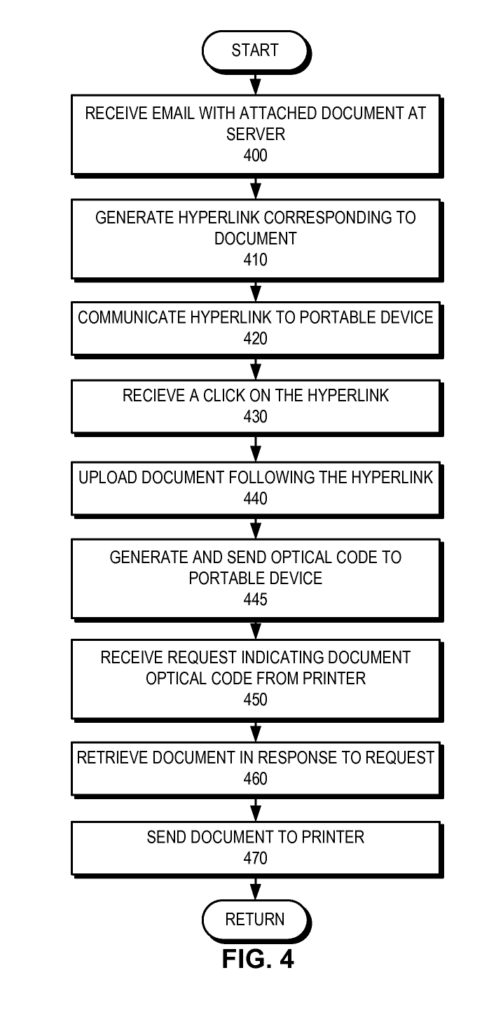

The email/document server can receive and store the document, generate an optical code corresponding to the document, and respond to requests for the document based on the optical code. FIG. 4 presents a flow chart illustrating the process of facilitating document printing at an email/document server in accordance with an embodiment. During operation, the document server receives an email with attached document (operation 400). Next, the server generates a hyperlink corresponding to the document (operation 410). Subsequently, the server communicates the hyperlink to the portable device (operation 420). The server then receives a click on the hyperlink (operation 430). In response, the server optionally uploads the document to a storage device (such as a file server) (operation 440). Subsequently, the server sends an optical code corresponding to the stored document back to the portable device (operation 445). Upon receiving a request corresponding to the optical code from the printer (operation 450), the server retrieves the document in response to the request (operation 460), then sends the document to the printer (operation 470).

### Controlling Access to the Optical Code

In order to provide additional security, the hyperlink together with a secret shared between the mobile device and the server can be used to determine the document's address. For example, customized software on the mobile device may combine the shared secret and hyperlink to determine the information to embed in the optical code. The customized software can be password-protected or secured by other, stronger authentication mechanisms so that even if the portable device is stolen, a malicious user still may not be able to acquire the optical codes necessary to access the user's documents.

Another security addition provides authenticity for the downloaded optical code. The hyperlink may contain a hash of the optical code, which is used to authenticate the optical code after it is downloaded. Additional salt (random data) can be added to the optical code when computing the hash and sent to user for verification as well.

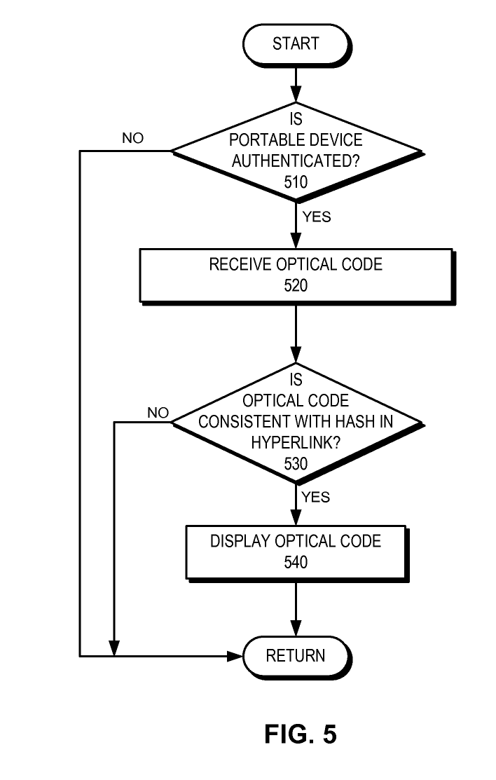

FIG. 5 illustrates the process of controlling access to the document optical code in accordance with an embodiment. During operation, the system first determines whether the portable device is authenticated (operation 510). In one embodiment, the authentication can be based on a shared secret between the portable device and the server, and optionally information contained in the hyperlink. If the device cannot be authenticated, the system does not perform further actions. If the device is successfully authenticated, it then receives the optical code corresponding to the hyperlink (operation 520). Subsequently, the portable device checks whether the optical code is consistent with a hash value contained in the hyperlink by performing a hash function on the information carried in the optical code (operation 530). If the optical code is consistent with the hash value, the portable device displays the optical code (operation 540). Otherwise, the system returns and does not perform any further action with the received optical code.

### Exemplary Portable Device

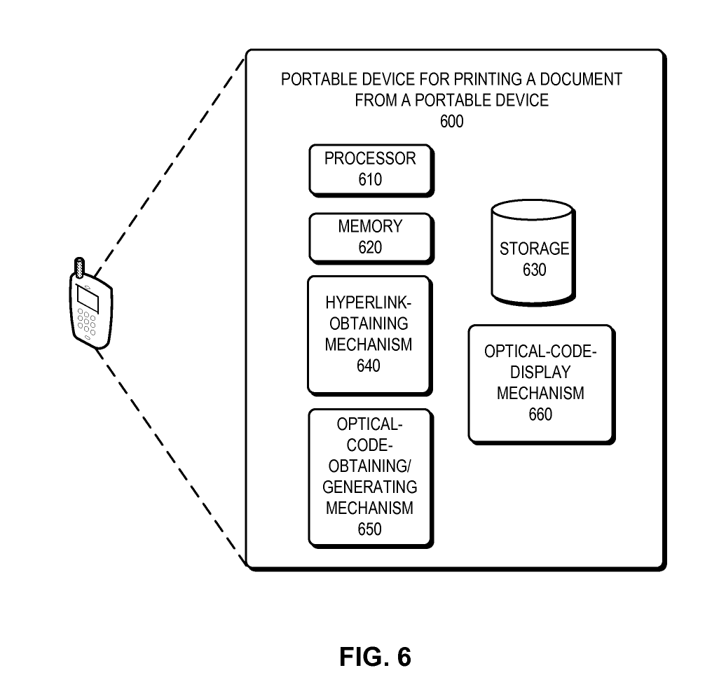

FIG. 6 presents an exemplary portable device for printing a document from a portable device in accordance with an embodiment. Portable device 600 for printing a document from a portable device comprises a processor 610, a memory 620, a storage 630, a hyperlink-obtaining mechanism 640, an optical-code-obtaining/generating mechanism 650, and an optical-code-displaying mechanism 660, all of which can be in communication with each other through various means.

Storage 630 stores programs to be executed by processor 610. Specifically, storage 630 stores a program that implements a system (application) for printing a document from a portable device. During operation, the application program can be loaded from storage 630 into memory 620 and executed by processor 610. As a result, portable device 600 for printing a document from a portable device can perform the functions described above.

During operation, hyperlink-obtaining mechanism 640 receives a hyperlink. Next, optical-code-obtaining/generating mechanism 650 follows the hyperlink and obtains/generates an optical code corresponding to the document after the hyperlink is followed. Subsequently, optical-code-displaying mechanism 660 displays the optical code to a printer. As a result, the printer can retrieve and print the document based on the optical code.

### Exemplary Email/Document Server

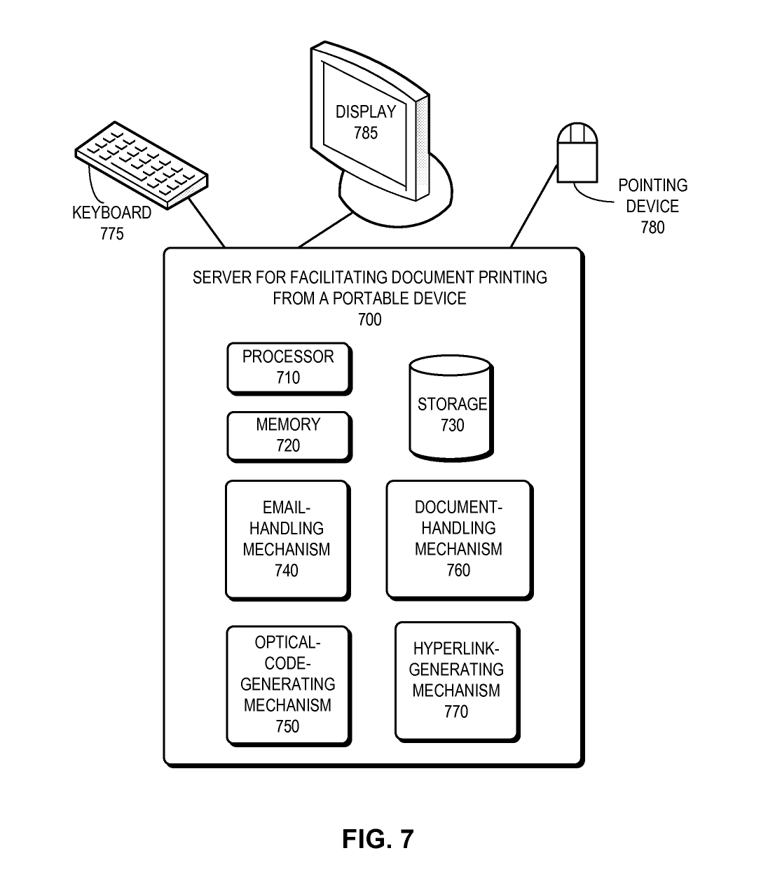

FIG. 7 presents an exemplary email server for facilitating document printing from a portable device in accordance with an embodiment. Email server 700 for facilitating document printing from a portable device includes a processor 710, a memory 720, a storage 730, an email-handling mechanism 740, an optical-code-generating mechanism 750, a document-handling mechanism 760, and a hyperlink-generating mechanism 770.

Storage 730 stores programs to be executed by processor 710. Specifically, storage 730 stores a program that implements a system (application) facilitating document printing from a portable device. During operation, the application program can be loaded from storage 730 into memory 720 and executed by processor 710. As a result, server 700 can perform the functions described above. Server 700 can be coupled to an optional display 785, keyboard 775, and pointing device 780.

During operation, email-handling mechanism 740 receives an email with an attached document. Hyperlink-generation mechanism 770 then inserts a hyperlink corresponding to the attached document in the email. Upon a portable device which retrieves the email following the hyperlink, optical-code-generating mechanism 750 generates an optical code corresponding to the document. In addition, document-handling mechanism 760 uploads the document to a publicly accessible address, which is encoded in the optical code. Subsequently, upon a request by a printer (which scans and decides the optical code displayed by a portable device), the document is delivered to the printer.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A computer-implemented method for printing a document from a portable device, wherein the portable device includes a processor, the method comprising:
receiving a hyperlink associated with a document;
following the hyperlink
obtaining a document optical code in response to the hyperlink being followed; and
displaying the optical code to a printing device, thereby allowing the printing device to obtain and print the document.

2. The method of claim 1, wherein the hyperlink is included in an email header, in an email body, or in an attachment of an email.

3. The method of claim 1, wherein the hyperlink is included in a Short Message Service (SMS) message.

4. The method of claim 1, wherein the hyperlink points to the document optical code.

5. The method of claim 4, wherein obtaining the document optical code further comprises following the hyperlink to download the optical code.

6. The method of claim 1, wherein the hyperlink points to the document to be printed.

7. The method of claim 6, wherein obtaining the document optical code further comprises generating the optical code corresponding to the document when the hyperlink is followed.

8. The method of claim 1, wherein the hyperlink includes a hash of the document optical code for verification.

9. The method of claim 1, wherein obtaining the document optical code comprises authenticating the portable device.

10. An apparatus for printing a document from a portable device comprising:
a receiving mechanism configured to receive a hyperlink associated with a document;
a hyperlink activation mechanism configured to follow the hyperlink;
an optical-code-obtaining mechanism configured to obtain a document optical code in response to the hyperlink being followed; and
a display configured to display the optical code to a printing device, thereby allowing the printing device to obtain and print the document.

11. The apparatus of claim 10, wherein the hyperlink is included in an email header, in an email body, or in an attachment to an email.

12. The apparatus of claim 10, wherein the hyperlink is included in a Short Message Service (SMS) message.

13. The apparatus of claim 10, wherein the hyperlink points to the document optical code.

14. The apparatus of claim 13, wherein while obtaining the document optical code, the optical-code-obtaining mechanism is further configured to follow the hyperlink to download the optical code.

15. The apparatus of claim 10, wherein the hyperlink points to the document to be printed.

16. The apparatus of claim 15, further comprising an optical-code-generating mechanism configured to generate an optical code corresponding to the document when the hyperlink is followed.

17. The apparatus of claim 10, wherein the hyperlink includes a hash of the document optical code for verification.

18. The apparatus of claim 10, further comprising an authentication mechanism configured to authenticate the portable device while obtaining the document optical code.

19. A computer-readable storage device storing instructions that when executed by a computer cause the computer to perform a method for printing a document from a portable device, the method comprising:
receiving a hyperlink associated with a document;
following the hyperlink;
obtaining a document optical code in response to the hyperlink being followed; and
displaying the optical code to a printing device, thereby allowing the printing device to obtain and print the document.

20. The computer-readable storage device of claim 19, wherein the hyperlink is included in an email header, in an email body, or in an attachment of an email.
